(19) United States
(12) Patent Application Publication
(10) Pub. No.: US 2009/0217764 A1
(43) Pub. Date: Sep. 3, 2009

(54) METHOD FOR NONDESTRUCTIVE TESTING OF A TESTING BODY HAVING AT LEAST ONE ACOUSTICALLY ANISOTROPIC MATERIAL AREA

(76) Inventors: Michael Kröning, Saarbrücken (DE); Andre Bulavinov, Saarbrücken (DE); Krishna Mohan Reddy, Saarbrücken (DE)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/162,225

(22) PCT Filed: Dec. 21, 2006
(86) PCT No.: PCT/EP2006/012419

§ 371 Date: Nov. 7, 2008

(30) Foreign Application Priority Data
Jan. 27, 2006 (DE) 10 2006 003 978.5

(51) Int. Cl. G01N 29/26

(52) U.S. Cl. 73/628

(57) ABSTRACT

A method is described for nondestructive testing of a test body having at least one acoustically anisotropic material area using ultrasound. The method of the invention includes ascertaining or providing directionally specific sound propagation properties which describe an acoustically anisotropic material area; coupling ultrasonic waves into the acoustically anisotropic material area of the test body; receiving ultrasonic waves reflected from an interior of the test body using ultrasonic transducers; and analyzing ultrasonic signals generated by the ultrasonic transducers so that an analysis is performed which is directionally-selective on a basis of directionally-specific sound propagation properties of the anisotropic material.

### BACKGROUND OF THE INVENTION

1. Field of the Invention

The invention relates to a method for the nondestructive testing of a test body having at least one acoustically anisotropic material area using ultrasound.

2. Description of the Prior Art

Nondestructive ultrasonic testing methods on test bodies which comprise acoustically isotropic solid materials which are to be performed for the purposes of a flaw checking, that is, to find cracks, material inhomogeneities, etc., are well-known. The requirement for a successful application of testing methods of this type is to provide the most uniform and linear propagation possible of ultrasonic waves coupled inside a particular test body. To fulfill this, the material which a particular test body comprises is desired have constant properties in sound acoustics over the entire volume to be tested. That is for example having an isotropic density distribution and isotropic elastic properties. If this requirement is fulfilled, these testing methods allow reliable flaw detection, detection of an exact spatial flaw location, and finally the implementation of flaw imaging, on the basis of which the size and shape of the flaw is recognizable, using suitable ultrasonic signal analysis methods. Reference is made to DE 33 46 534 A1 as representative of ultrasonic testing systems of this type, which discloses an ultrasonic image representation unit providing a group radiator ultrasonic test head, which comprises a linear array of ultrasonic individual transducer elements, which are activated individually or in groups at a predefined scanning frequency during movement in the scanning direction. The quality of the flaw image reconstruction, which finally also determines the quantitative information in regard to flaw type, flaw location, and flaw size, is a function of a plurality of parameters determining the ultrasonic coupling into the test body, the ultrasonic wave detection, and reconstruction techniques which analyze the received ultrasonic signals.

The materials accessible to the ultrasonic testing technology up to this point using propagation velocities of acoustic waves, which are independent of their propagation direction, are referred to as acoustically isotropic materials. However, if the speed of sound of the ultrasonic waves coupled into the materials are a function of their particular propagation directions, these materials are referred to as anisotropic. A known, natural anisotropic material is wood, for example, which may only be tested for material flaws with restrictions, if at all, using conventional ultrasonic testing technologies. Further anisotropic materials are represented by fiber composite or coated materials, for example, which are preferably used in modern light construction designs. The reason for the unsatisfactory ability to test anisotropic materials of this type is the structure-dependent type of the propagation of ultrasonic waves having a location-dependent and material-density-dependent speed of sound. In addition, in contrast to isotropic materials, in which only two types of modes of oscillation of volume waves may occur, namely longitudinal and transverse modes, three propagation modes are to be expected in anisotropic materials, because two orthogonal transverse modes may already exist. In isotropic materials, the oscillation of the longitudinal mode is always oriented parallel and that of the transversal mode is always oriented perpendicular to the propagation direction. In contrast, in anisotropic materials, so-called quasi-longitudinal and quasi-transversal waves exist, whose polarization deviations may already cause significant effects in the flaw image reconstruction even at low speed of sound differences.

However, the testing of test bodies which comprise different acoustically isotropic materials, such as test bodies assembled in layers, is not capable of ensuring exact spatial flaw location within the test body using the currently known testing methods, because the ultrasonic waves are refracted along their propagation direction at the interfaces of adjoining material layers. Refraction effects already occur in principle in ultrasonic testing in immersion technology at the interfaces between water and steel, for example, by which the flaw localization described above is sometimes significantly restricted, as refraction or diffraction occurrences even at interfaces between two otherwise isotropic materials make localizing flaws nearly impossible. The reason for this are the lack of knowledge of the sound path, which may no longer be assumed to be linear, and thus also of the lack of knowledge of the effective speed of sound. The flaw detection itself may also be deficient using a limited number of angles of incidence, because the noise may not reach the flaw location due to diffraction effects. For this reason, safety-relevant structural materials are tested using the largest possible number of angles of incidence, the so-called group radiator technique, as may be inferred from previously cited DE 33 46 534 A1, being used.

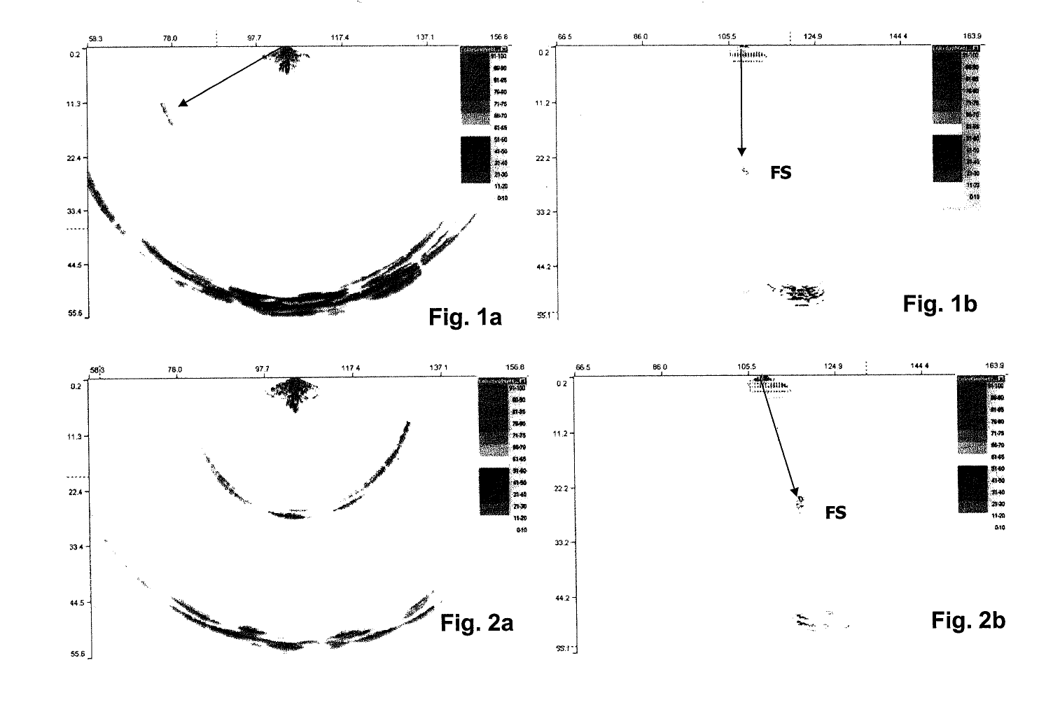

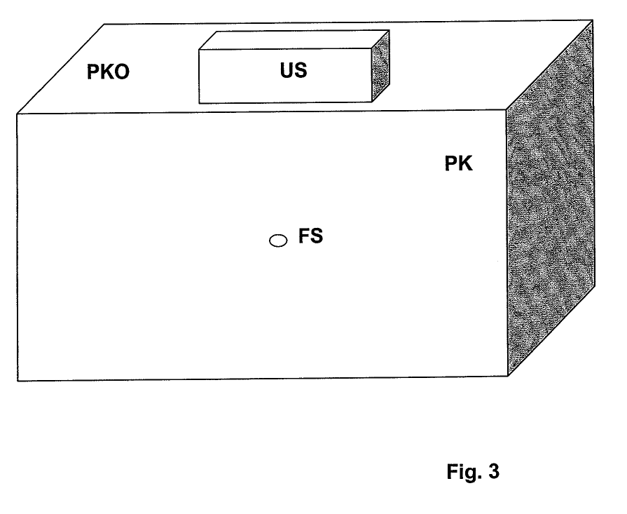

To obtain a quantitative impression of the influence of acoustic anisotropic materials on the actual ultrasonic wave propagation ratio, reference is made to the testing result shown in FIG. 1a, which has been obtained using an ultrasound group radiator test head US on a test body PK comprising carbon fiber composite material, according to the test situation outlined in FIG. 3. The test body PK studied using the ultrasonic wave group radiator test head US is a test body PK having a flat test body surface PKO and comprising carbon fiber composite material, inclined at a fiber orientation of 15° to the test body surface PKO. The speed of sound in the fiber direction is approximately 3 times greater than that in the propagation direction perpendicular thereto. Furthermore, a flaw FS introduced as a model reflector is introduced within the test body PK, which is located directly below the ultrasonic wave group radiator US resting on the test body surface PKO.

A two-dimensional sector image of a conventionally operated ultrasound group radiator US is shown in FIG. 1a, that is, all ultrasonic transducers are used jointly as ultrasonic wave transmitters and are capable of detecting the ultrasonic waves reflected within the test body. It may be inferred from the sector image shown in FIG. 1a that the sound coupling location, that is, the location of the ultrasonic wave group radiator test head, is situated centrally on the abscissa of the illustrated coordinate system. The received signals occurring in the area of the sound coupling originate from coupling effects proximal to the test body surface, but do not themselves represent flaws within the test body. The reflection signals, which are situated in a semicircle at a distance from the coupling point, represent reflection events on the rear wall of the test body, that occur at nearly all angles of incidence. Due to the measuring situation which is predefined by the test body with regard to the location of the flaw artificially introduced into the test body, in a case of a test body comprising an isotropic material, the reflector location must lie exactly below the recognizable sound entry point. In the sector image shown in FIG. 1a, however, no indication is obtained at 0°, but rather a reflector event R is obtained at angles around 45°. This testing result makes it clear that the anisotropic material of the test body results in corrupted location information of a flaw actually present in the test body.

Coupling of the ultrasonic waves in the direction of the fiber structure also does not result in another satisfactory analysis result.

A sector image of a conventionally operated group radiator having a radiation direction longitudinal to the direction of the fiber structure is shown for this purpose in FIG. 2a, from which it may be inferred that because of diffraction appearances at nearly all angles of incidence, the test reflector artificially introduced into the test body may be seen. This is shown in the sector image of FIG. 2a as a semicircle having a smaller radius. It is obvious that the fundamental proof of the presence of flaws is possible, but localization of flaws and also characterization in regard to the size and type of the flaw are not possible.

### DESCRIPTION OF THE INVENTION

The invention is a method for the nondestructive testing of a test body having at least one acoustically anisotropic material area in such a manner so that a reliable flaw detection is possible with more precise specification of the spatially exact location, type, and size of the flaw located within the acoustically anisotropic material area.

According to the invention, a method for the nondestructive testing of a test body having at least one acoustically anisotropic material area using ultrasound is distinguished by the sequence of the following method steps:

Firstly, the directionally-specific sound propagation properties, which describe the acoustically anisotropic material area, are to be ascertained and/or appropriately provided by access to an already existing data reserve. Because the sound propagation behavior within test bodies having anisotropic material areas may be understood and described in detail on the basis of elastodynamic approaches, for example, it is possible to obtain detailed findings in this regard, preferably involving experimental studies about the sound-acoustic properties of nearly arbitrary anisotropic test bodies and making them available for further applications using suitable mathematical representations, such as for example, with so-called rigidity matrices. In particular, directionally-specific sound propagation speeds within particular test bodies to be tested may be inferred from rigidity matrices of this type.

With the aid of these findings describing the sound-acoustic properties of a test body to be tested, it is possible by coupling ultrasonic waves into the acoustically anisotropic material area of the test body and correspondingly by receiving ultrasonic waves reflected in the interior of the test body using a plurality of ultrasonic transducers, to analyze the ultrasonic signals detected in a directionally-selective manner on the basis of the directionally-specific sound propagation properties.

In the directionally-selective ultrasonic signal analysis according to the invention, the phase relationships of individual elementary waves originating at different detection directions, due to corresponding reflection events within the testing body, are detected. The reception of the ultrasonic waves is performed jointly with the emission and coupling of ultrasonic waves into the test body using an ultrasonic wave group radiator test head and directionally-selective ultrasonic wave analysis being performed using a signal analysis method which is explained hereafter. In consideration of the sound-acoustic anisotropy of the material areas present within the test body, the detected ultrasonic wave field to be analyzed is finally adapted in such a manner that a quasi-standard test situation is provided, as is also performed in the analysis of ultrasonic signals which originate from acoustically isotropic test bodies.

For this purpose, sound runtimes are calculated, which each ultrasonic wave requires from the location of its origin, which corresponds to the coupling location on the test body surface and at which an ultrasonic transducer element used as the transmitter is provided, to a spatial point located within a test body area to be reconstructed and back to the location of a receiver giving consideration of the anisotropic material properties and/or elastic material constants.

To be able to perform a directionally-selective analysis of the ultrasonic waves reflected within the test body with a largely complete volume acquisition of the test body, an ultrasound group radiator test head having a number n of ultrasonic transducers is placed on a surface of the test body, via which ultrasonic waves may be coupled into the test body and also corresponding reflected ultrasonic waves may be detected from the test body.

The ultrasonic transducers are preferably applied to the surface of the test body directly or using suitable coupling means. The ultrasonic transducers may be attached to the surface of the test body in either an unordered form or in an ordered form of one-dimensional arrays (along a row), two-dimensional arrays (in a field), or three-dimensional arrays (as a function of the three-dimensional surface of the test body).

The n ultrasonic transducers are each advantageously capable of coupling ultrasonic waves into the test body and also receiving ultrasonic waves, that is, they are used and/or activated as both ultrasonic transmitters and ultrasonic receivers. The use of exclusive ultrasonic transmitters and ultrasonic receivers is also conceivable, but this results in a larger number of ultrasonic transducers to be applied for the same spatial resolution of the measurement results.

Piezoelectric transducers are preferably suitable as the ultrasonic transducers, but the use of transducers which are based on electromagnetic, optical, or mechanical action principles is also possible.

The n ultrasonic transducers are advantageously assembled in a manually handled ultrasonic test head, which allows simple employment and application to the test body surface. Other applications of the ultrasonic transducers, for example, to diametrically opposite surfaces of the test body, result as a function of the size and shape of the test body and of the particular testing task posed. It has been shown that an optimum spatial resolution of the measurement results may be achieved using the method according to the achievement of the object if the number of the ultrasonic transducers to be provided is selected as equal to or greater than 16.

In a second step, a first ultrasonic transducer or a first group of ultrasonic transducers is selected from the total number of the n ultrasonic transducers. If a group of ultrasonic transducers is selected, the number i of the ultrasonic transducers associated with the group is less than the total number n of ultrasonic transducers.

The establishment of the number i of the US transmitters determines the elastic energy coupled into the test body per activation of the US transmitter, under the condition that the i US transmitters are activated simultaneously. The greater the selected number of all simultaneously active transmitters, the higher the elastic energy coupled into the test body. Furthermore, i ultrasonic transducers are advantageously provided as the transmitters in such a manner that i directly adjacent ultrasonic transducers are selected as much as possible as a flat coherent ultrasonic transmitter array. Under the condition that all transmitters transmit simultaneously, the number i of the US transmitters and the concrete composition of the transmitter group, in particular their configuration on the test body surface, also determines the overall emission characteristic (aperture) of the transmitter group and, in addition, the sensitivity and the resolution capability of the measurements.

Furthermore, the first ultrasonic transducer, that is, i=1, or all i ultrasonic transducers belonging to the first group, are activated to emit ultrasonic waves, which are coupled into the test body. At interference points within the test body or at the test body surfaces diametrically opposite to the particular coupling areas, the ultrasonic waves are reflected and again reach the surface area of the n ultrasonic transducers applied to the test body surface, of which all n or only a limited part m receive the ultrasonic waves, the number m always being greater than the number i of the ultrasonic transducers participating in the ultrasound emission.

After each individual measuring pulse, the ultrasonic waves received by the m ultrasonic transducers used as US receivers or at most by all n US transducers are converted into ultrasonic signals and stored, that is , are fed to a corresponding storage unit and stored therein.

As an alternative to a simultaneous activation of i selected ultrasonic transducers which belong to a group and are used as US transmitters, it is also possible to excite the US transmitters in phase-shifted manner, that is , partially or completely time-shifted. In this manner, as previously described with regard to the phased array principle, the direction of incidence and/or the focusing of the elastic energy of the ultrasonic waves may be performed on a specific volume area within the test body. The aperture of the i US transmitters may, inter alia, thus also be set optimized to specific directions of incidence or focuses.

It is not fundamentally necessary to modulate the ultrasonic transducers used as transmitters so that all US transmitters are activated identically. For reasons of possibly simplified or special analysis of the measured signals, it may be advantageous to assign the received measured signals to the particular US transmitters. For this purpose, the i ultrasonic transducers associated with a group are activated to be modulated, that is, each individual ultrasonic transducer is activated using a differentiable modulation, so that the ultrasonic waves coupled into the test body may be detected in a transmitter specific manner.

After providing one or more measurement pulses, there is an altered selection of US transmitters which generate ultrasonic waves. For reasons of better measurement sensitivity, the multiple measurement pulses may be provided using a uniform US transmitter configuration to obtain an improved signal-to-noise ratio in the course of statistical signal analysis. In the case of a single ultrasonic transducer used as a US transmitter at a time, another ultrasonic transducer is selected for the emission of ultrasonic waves. An ultrasonic transducer which is directly adjacent to the ultrasonic transducer, which was last activated, is preferably selected. In the case of multiple ultrasonic transducers composing a group, a group of ultrasonic transducers is again to be formed, whose number i is identical, but whose composition is also different from the previously selected composition, at least by one ultrasonic transducer.

In this manner, the test body is irradiated with ultrasonic waves from various coupling areas. Concurrently with the first measuring pulse or the first measuring cycle, which is composed of multiple first measuring pulses, the reflected ultrasonic waves are also received by the new US transmitter configuration using all n ultrasonic transducers or part m of the ultrasonic transducers and converted into ultrasonic signals, which are finally also stored. All n or m ultrasonic transducers used for receiving ultrasonic waves remain unchanged in spite of the altered US transmitter configuration, to allow the simplest possible measured signal analysis, as may be inferred from the following.

The previously described method steps of the repeated activation of a further ultrasonic transducer or a group of ultrasonic transducers having an altered composition of ultrasonic transducers and of the reception and storage of the measured signals are repeated a number of times which may be predefined to ascertain the sound transmission and/or reflection capability of the test body from a plurality, preferably from all possible positions of incidence in this manner.

For example, if only one ultrasonic transducer, that is, i=1, is activated as a US transducer, at most n measuring pulses or n measuring cycles, each comprising a selectable number of measuring pulses, may be performed. If a group comprising i ultrasonic transducers is activated, at most all i permutations of n existing ultrasonic transducers may be performed.

As a result of the performance of the above method steps, a plurality of the m measured signals stored per measuring pulse and/or measuring cycle is obtained, which is then analyzed in consideration of a targeted test body test. A special aspect is the possibility of later analysis of the stored measured signals after performance of the actual measurement of the test body. The analysis of the ultrasonic signals is performed off-line using a reconstruction algorithm, which is applied in consideration of a virtually predefinable angle of incidence and/or a virtual focus of the coupled ultrasonic waves in the test body. With the aid of reconstruction algorithms of this type, synthetic three-dimensional images of the sound transmission and/or reflection properties of the test body may be calculated from the stored ultrasonic signals without additional further ultrasonic measurements being required. This reconstruction principle is based on the application of the synthetic aperture focusing technique (SAFT), which comprises all received ultrasonic signals being projected as much as possible on a shared time axis. All ultrasonic signals reflected from a specific reflector and/or from a specific flaw are added in phase giving consideration to the anisotropic sound propagation properties of the test body material and a phase adaptation connected thereto. A subsequent reconstruction of arbitrary angles of incidence uses a phase-shifted addition of the received signals of various ultrasonic receivers. A synthetical reconstruction of nearly any angle of incidence through the off-line analysis is possible and thus the performance of an ultrasonic sweep through the data set is possible.

With the aid of the ultrasonic testing technology described above using a so-called pulsed group radiator system and a signal analysis suggested according to the invention with consideration of the intrinsic material sound acoustic anisotropic material properties of the test body, an array of advantages may be achieved with the principle of so-called inverse phase adaptation:

The pulsed group radiator technology using inverse phase adaptation allows a flaw detection and a flaw image reconstruction for anisotropic materials with a quality and reliability which corresponds to the ultrasonic technology study in a typical manner on isotropic materials.

Depending on the selection of the number of transmitting ultrasonic transducers, the distance, and the configuration of the sensor system, optimizations may be performed as a function of the anisotropy parameters of the test body to be studied.

Ultrasonic testing in immersion technology is also possible using the method of the invention for studying heterogeneous and/or sound-acoustic anisotropic materials. Test body geometries having complexly designed surface geometries are also possible with the method of the invention by the sound-acoustic coupling via a liquid layer between group radiator head and test body surface to be studied. This possibility makes it easier to produce and use the testing system at low cost and low sensor-technology outlay.

### BRIEF DESCRIPTION OF THE INVENTION

The invention is described for exemplary purposes hereafter without restriction of the general concept of the invention on the basis of exemplary embodiments with reference to the drawings. In the figures:

FIGS. 1a, b show sector image illustrations through an anisotropic test body;

FIGS. 2a, b show sector image illustrations through an anisotropic test body; and

FIG. 3 shows a schematic illustration of the experimental test situation.

### DETAILED DESCRIPTION OF THE INVENTION

As already explained above, a flaw within an anisotropic test body cannot be localized from the sector image from FIG. 1a, with only the presence of a flaw being recognizable through the backscatter signal FS. In contrast, if the method according to the invention is used as previously described and the ultrasonic waves detected from all volume areas are analyzed with consideration of their directionally-specific sound wave propagation speeds, even with an anisotropic material composition of the test body PK to be studied, the location, shape, and size of a flaw FS may be exactly represented. In FIG. 1b, the spatial location of the flaw FS is shown directly vertically below the location of the soundwave coupling, as is also the case in the testing situation shown in FIG. 3.

It is also possible with the method according to the invention by providing ultrasonic waves traveling in the direction of the fiber structure to detect the exact location of the flaw FS according to the sector image illustration in FIG. 2b and to represent it, entirely in contrast to the application of ultrasonic testing technologies known up to this point, which result in a sector image as shown in FIG. 2a, which has already been explained in detail above in the introduction.

### LIST OF REFERENCE NUMERALS

FS flaw
US ultrasonic group radiator test head
PK test body
PKO test body surface

1-14. (canceled)

15. A method for nondestructive testing of a test body including at least one acoustically anisotropic material area using ultrasound, comprising:
a) ascertaining or providing directionally specific sound propagation properties describing the acoustically anisotropic material area;
b) coupling ultrasonic waves into the acoustically anisotropic material area of the test body;
c) receiving ultrasonic waves reflected from an interior of the test body using ultrasonic transducers; and
d) analyzing ultrasonic signals generated by the ultrasonic transducers to perform an analysis which is directionally-selective on a basis of the directionally-specific sound propagation properties of the anisotropic material area.

16. The method according to claim 15, wherein:
the directionally specific sound propagation properties represent directionally specific sound propagation speeds and are calculated from a rigidity matrix describing the at least one acoustically anisotropic material area or are ascertained from an experimental directionally dependent speed of sound measurement.

17. The method according to claim 16, wherein the coupling and receiving of ultrasonic waves comprises:
a) providing n ultrasonic transducers on a surface of the test body;
b) selecting and activating a first transducer or a first group of transducers including i ultrasonic transducers from the n ultrasonic transducers for emitting ultrasonic waves into the test body, with i<n;
c) receiving ultrasonic waves reflected from an interior of the test body using m ultrasonic transducers, with i<m≦n, and generating m ultrasonic signals;
d) storing the m ultrasonic signals;
e) selecting and activating another transducer or another group of transducers having i ultrasonic transducers, which differs at least by one ultrasonic transducer from the first group, for emitting ultrasonic waves and performing method steps c) and d);
f) repeatedly executing step e) using selection of a further ultrasonic transducer or a further group of i ultrasonic transducers with the further ultrasonic transducer or the further group of ultrasonic transducers having i ultrasonic transducers differing from an already selected ultrasonic transducer or an already selected group of ultrasonic transducers including i ultrasonic transducers; and
g) analyzing the stored ultrasonic signals.

18. The method according to claim 17 wherein:
the n ultrasonic transducers are provided in a one-dimensional, two-dimensional, or three-dimensional arrayed configuration.

19. The method according to claim 17, comprising:
activating all i ultrasonic transducers belonging to a group simultaneously without a phase shift.

20. The method according to claim 18, comprising:
activating the i ultrasonic transducers belonging to a group with each individual ultrasonic transducer being activated using a differentiable modulation so that the ultrasonic waves coupled into the testing body are detected relative to a specific transmitter.

21. The method according to claim 17, comprising:
selecting the i ultrasonic transducers belonging to a group so that directly adjacent ultrasonic transducers are selected in a linear or planar array.

22. The method according to claim 17, wherein:
n is selected as ≧16.

23. The method according to claim 17, comprising:
activating ultrasonic transducers using electromagnetic, optical, mechanical or piezoelectric transducer principles.

24. The method according to claim 17, comprising:
analyzing of the ultrasonic signals using a reconstruction algorithm after performing sound transmission through the test body using ultrasound; and
selecting the reconstruction algorithm with a virtually predefinable angle of incidence and/or section and/or 3-D area using a virtual focusing of coupled ultrasonic waves in the test body and is applied to the stored ultrasonic signals.

25. The method according to claim 24, comprising:
analyzing the ultrasonic signals is performed using a phase adaptation of the ultrasonic waves received by the m ultrasonic transducers so that ultrasonic runtimes of each ultrasonic transducer used as a transmitter to each spatial point of the area of the test body to be reconstructed and back to each ultrasonic transducer used as a receiver are determined using anisotropic material properties or elastic material constants.

26. The method according to claim 17, comprising:
generating and storing each of the m ultrasonic transducers using an analog-digital conversion, in which the analog ultrasonic signals of the m ultrasonic transducers are converted into digital signals and stored in serial form.

27. The method according to claim 17, comprising:
receiving the ultrasonic waves reflected from the interior of the test body with all ultrasonic transducers being provided on the surface of the testing body, with m=n.

28. The method according to one claim 15, wherein:
the test body is entirely an acoustically anisotropic material
